(19) United States
(12) Patent Application Publication
(10) Pub. No.: US 2023/0176510 A1
(43) Pub. Date: Jun. 8, 2023

(54) IMAGE FORMING APPARATUS

(71) Applicant: KONICA MINOLTA, INC., Tokyo (JP)

(72) Inventor: Takashi YAMADA, Tokyo (JP)

(73) Assignee: KONICA MINOLTA, INC., Tokyo (JP)

(21) Appl. No.: 17/970,893

(22) Filed: Oct. 21, 2022

(30) Foreign Application Priority Data
Dec. 2, 2021 (JP) 2021-195868

(51) Int. Cl. G03G 15/20; G03G 15/00

(52) U.S. Cl. CPC G03G 15/2032; G03G 15/2064; G03G 15/657; G03G 2215/2032; G03G 2215/00645; G03G 2215/00413; G03G 2215/00455

(57) ABSTRACT

An image forming apparatus includes: an image former that forms an image on a continuous paper; a fixing unit that includes a pair of rotatable members and that nips the continuous paper between the rotatable members to convey the paper and fix the image formed on the paper by the image former; a conveying member different from the rotatable members; and a hardware processor. The image forming apparatus performs a paper conveying mode in which the image former does not form an image and at least the conveying member conveys the continuous paper. In the paper conveying mode, the hardware processor determines to press the rotatable members against each other or to separate the rotatable members from each other according to a predetermined criterion and, based on the determination, conveys the continuous paper while keeping the rotatable members pressed against each other or separated from each other.

### CROSS-REFERENCE TO RELATED APPLICATIONS

The entire disclosure of Japanese Patent Application No. 2021495868 filed on Dec. 2, 2021 is incorporated herein by reference in its entirety.

### BACKGROUND

The present disclosure relates to an image forming apparatus.

### Description of Related Art

There is known an image forming apparatus that forms images on continuous paper. In conveying the continuous paper without forming images, the image forming apparatus separates an upper press roller and a lower press roller of a fixing unit (switches from the pressed state to the separated state) and then conveys the paper by using conveying rollers that are different from the rollers of the fixing unit.

For example, JP2019-104174A discloses an image forming apparatus that separates the fixing upper roller and the fixing lower roller of the fixing unit when the printing action is interrupted and conveys paper by using conveying rollers other than the rollers oldie fixing unit.

For another example, a known image forming apparatus performs a paper conveying mode when a roll of continuous paper is replaced with another roll, in order to convey the joint of the rolls to the downstream of an image forming unit in the paper conveying direction. When a paper having creases or papers joined with tapes pass through the fixing nip, the marks of the creases are left on the surface of the lower press roller of the fixing unit. Such a lower press roller may fix images unevenly and produce defective images. To avoid this, in the paper conveying mode, the upper press roller and the lower press roller of the fixing unit are separated from each other, and the paper is conveyed by the conveying rollers different from the rollers of the fixing unit.

### SUMMARY

To avoid slackening of paper in the downstream of the fixing unit in the paper conveying direction, the conveying rollers are provided in the downstream of the fixing unit in the paper conveying direction, and the conveying rollers typically convey the paper in the paper conveying mode. In order to keep tension between the fixing unit and the conveying rollers, the paper conveying speed of the conveying rollers needs to be equal to or greater than the paper conveying speed of the fixing unit. The paper conveying power of the conveying rollers is therefore weaker than the paper conveying power of the fixing unit. However, in order to convey a bending-resistant thick paper, the conveying rollers are required to have a stronger paper conveying power so as to bend the paper at the winding roller part on the paper conveying path (e.g., the part enclosed by the alternate-long-and-short dash line in FIG. 1). The conveying rollers having a weak paper conveying power cannot convey such a bending-resistant thick paper.

Creases on the lower press roller can be smoothed by heating the lower press roller. Therefore, a heat source may be provided inside the lower press roller. This allows the upper and lower press rollers to be pressed against each other in the paper conveying mode. However, such a configuration requires installation of a heater inside the lower press roller and electric power. Further, according to the configuration including the heat source in the lower press roller, heating the surface of the roller takes time and prolongs the warm-up time.

Objects of the present invention include providing an image forming apparatus that is less likely to cause creases on rotatable members, the rotatable members forming, a nip of the fixing unit in the paper conveying mode, and that can stably convey both thick paper and thin paper.

To achieve at least one of the abovementioned objects, according to an aspect of the present invention, there is provided an image forming apparatus including: an image former that forms an image on a continuous paper; a fixing unit that includes a pair of rotatable members configured to be pressed against each other or be separated from each other and that nips the continuous paper between the rotatable members to convey the continuous paper and fix the image formed on the continuous paper by the image former; a conveying member different from the rotatable members; and a hardware processor, wherein an operation mode of the image forming apparatus includes a paper conveying mode in which the image former does not form an image and at least the conveying member conveys the continuous paper, and in the paper conveying mode, the hardware processor determines to press the rotatable members of the fixing unit against each other or to separate the rotatable members from each other according to a predetermined criterion and, based on the determination, conveys the continuous paper while keeping the rotatable members pressed against each other or separated from each other.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 shows a schematic configuration of an image forming apparatus;

FIG. 2 is a block diagram showing main functional components of the image forming apparatus;

FIG. 3 schematically shows the state of a fixing unit in an image forming mode;

FIG. 4 schematically shows the state of the fixing unit that is determined to be in the separated state in the paper conveying mode;

FIG. 5 schematically shows the state of the fixing unit that is determined to be in the pressed state in the paper conveying mode;

FIG. 6 is a flowchart of a paper-conveying-mode process A to be performed by a controller shown in FIG. 2;

FIG. 7 is a flowchart of a paper-conveying-mode process B to be performed by the controller shown in FIG. 2;

FIG. 8 schematically shows how the pressing force of the fixing unit is adjusted;

FIG. 9 is a flowchart of a pressing three adjustment process A to be performed by the controller shown in FIG. 2;

FIG. 10 shows an example of a paper speed detector;

FIG. 11 is a flowchart of a paper-conveying-mode process C to be performed by the controller shown in FIG. 2; and

FIG. 12 is a flowchart of a pressing force adjustment process B to be performed by the controller shown in

### DETAILED DESCRIPTION OF THE EMBODIMENTS

Hereinafter, embodiments of the present invention are described with reference to the drawings. However, the scope of the present invention is not limited to the disclosed embodiments.

### First Embodiment

### Configuration of Image Forming Apparatus 100

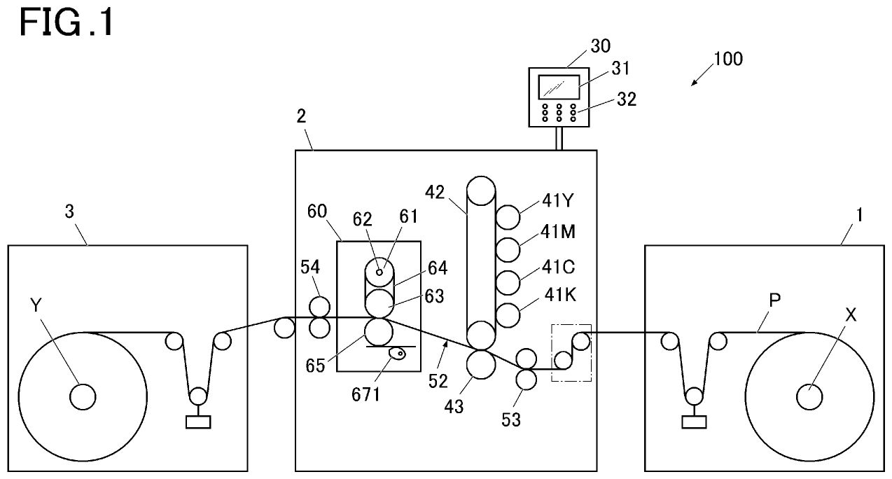

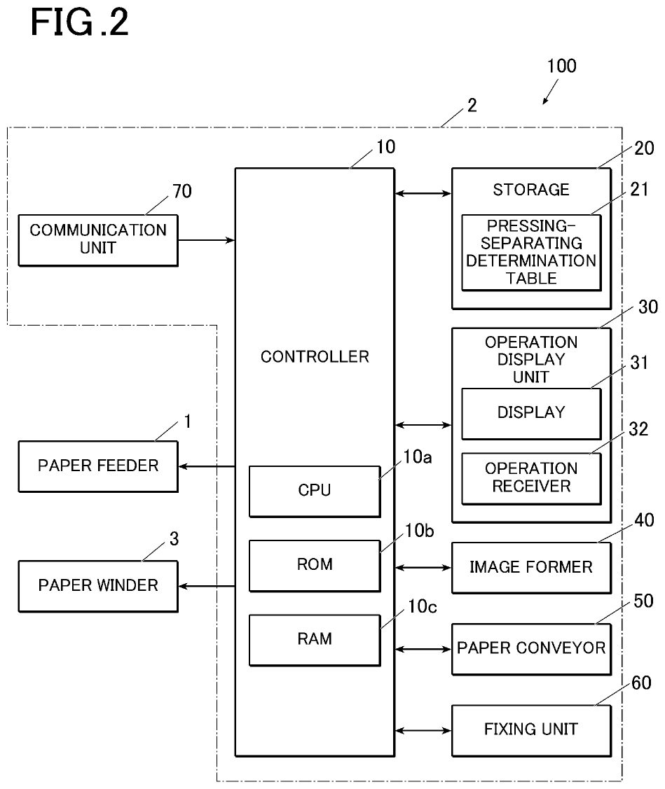

FIG. 1 is an entire configuration of an image forming apparatus 100 in a first embodiment viewed from the front. FIG. 2 shows main control components of the image forming apparatus 100. The image forming apparatus 100 is configured to form images on rolled continuous paper P, for example.

As shown in FIG. 1, the image forming apparatus 100 includes a paper feeder 1, a main body 2, and a paper winder 3 that are connected in this order from the upstream along the paper conveying direction in which the continuous paper P is conveyed. Although the paper feeder 1 and the paper winder 3 are configured as different bodies in FIG. 1, they may be configured as one body.

The paper feeder 1 is configured to feed the continuous paper P to the main body 2. The paper feeder 1 feeds the continuous paper P that is wound around a support shaft X to the downstream devices by driving a not-illustrated motor. The motor of the paper feeders is controlled by a not-illustrated controller.

The main body 2 electro-photographically torus images on the continuous paper P, which is feel by the paper feeder 1, by using the intermediate transfer method.

As shown in FIG. 2, the main body 2 includes a controller 10 (hardware processor), a storage 20, an operation display unit 30, an image former 40, a paper conveyor 50, a fixing unit 60, and a communication unit 70.

The controller 10 includes a central processing unit (CPU) 10a, a read only memory (ROM) 10b, and a random access memory (RAM) 10c. The CPU 10a reads a program corresponding to processing details from the ROM 10b, loads the program in the RAM 10c, and centrally controls operation of the components of the main body 2, the paper feeder 1, and the paper winder 3 in cooperation with the loaded program.

The storage 20 consists of a nonvolatile semiconductor memory (flash memory) and/or a hard disc drive, for example. The storage 20 stores input document data, various kinds of setting information, and image data. The setting information includes paper information regarding the loaded continuous paper P (e.g., paper type and basis weight). These data and so forth may be stored in the RAM 10c of the controller 10.

The storage 20 also stores a pressing-separating determination table 21. The pressing-separating determination table 21 stores paper information in association with flags. In the pressing-separating determination table 21, a flag indicating “pressing” is associated with paper information of a paper that cannot be conveyed when the upper press roller 63 and the lower press roller 65 of the fixing unit 60 are separated in the paper conveying mode; and a flag indicating “separating” is associated with paper information of a paper that can be conveyed even when the upper press roller 63 and the lower press roller 65 of the fixing unit 60 are separated from each other in the paper conveying mode. For example, paper information of a thick paper or a paper with a heavy basis weight is associated with the flag “pressing”, and paper information of a thin paper or a paper with a light basis weight is associated with the flag “separating”.

The pressing-separating determination table 21 is not limited to the one described above. The pressing-separating determination table 21 may store a list of paper information on papers that cannot be conveyed when the upper press roller 63 and the lower press roller 65 of the fixing unit 60 are separate in the paper conveying mode. Alternatively, the pressing-separating determination table 21 may store a list of paper information on papers that can be conveyed even when the upper press roller 63 and the lower press roller 65 of the fixing unit 60 are separated in the paper conveying mode.

The operation display unit 30 consists of a liquid crystal display (LCD) provided with a touchscreen, for example. The operation display unit 30 functions as a display 31 and an operation receiver 32.

The display 31 displays various operation screens, image conditions, and operation statuses of the respective functions in accordance with display control signals input by the controller 10.

The operation receiver 32 includes various operation keys including numeric keys, a start key, a paper conveying key, and a stop key. The operation receiver 32 receives the user's various input operations and outputs operation signals to the controller 10.

The image former 40 forms toner images of respective colors of yellow (Y), magenta (M), cyan (C), and black (K) on photoconductive drums 41Y, 41M, 41C, 41K on the basis of image data input from an external device (e.g., a personal computer) via the communication unit 70; sequentially transfers the toner images of four colors onto an intermediate transfer belt 42 (first transfer) to superpose the toner images; and transfers, using a transfer roller 43, the superposed four-color toner image onto the continuous paper P fed by the paper feeder 1 (secondary transfer), for example. The image former 40 thus forms (prints) an image on the continuous paper P.

The paper conveyor 50 includes a paper conveying path 52 provided with conveying rollers 53, 54 (conveying members).

Under the control of the controller 10, the paper conveyor 50 conveys the continuous paper P, which has been conveyed from the paper feeder 1 to the main body 2, to the image former 40; and the paper conveyor 50 conveys the continuous paper P on which the toner image has been formed by the image former 40 to the fixing unit 60. After the toner image is fixed on the continuous paper P by the fixing unit 60, the paper conveyor 50 conveys the continuous paper P to the paper winder 3.

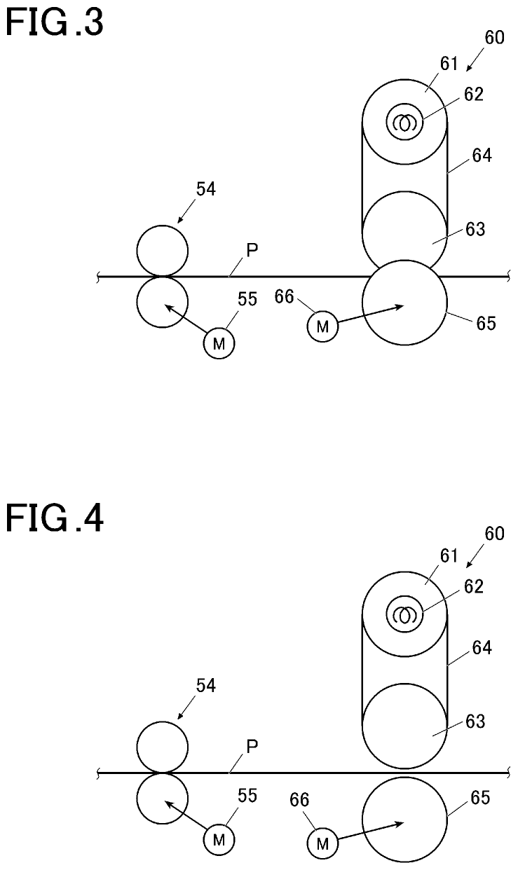

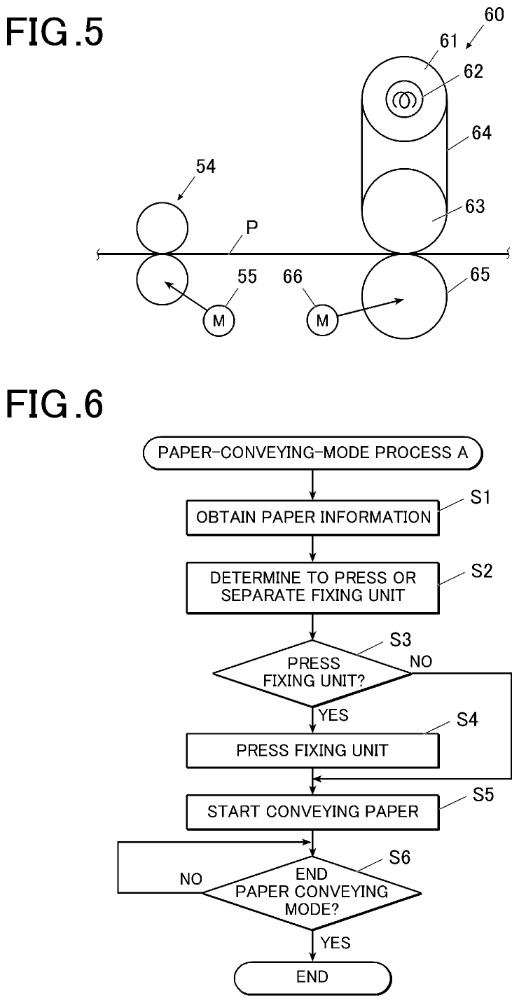

In this embodiment, a pair of conveying rollers 53 is provided at a position upstream from the fixing unit 60 and downstream front the paper feeder 1 in the paper conveying direction on the paper conveying path 52. Further, a pair of conveying rollers 54 is provided at a position downstream from the fixing unit 60 and upstream from the paper winder 3 in the paper conveying direction. Only either the conveying rollers 53 or the paper conveying rollers 54 may be provided. The conveying rollers 53, 54 are driven to rotate by their respective motors (e.g., the motor 55 shown in FIG. 3). The paper conveying power of the conveying rollers 54 is weaker titan the paper conveying power of the upper press roller 63 and the lower press roller 65 of the fixing unit 60 in order to keep the tension of the continuous paper P between the conveying rollers 54 and the fixing unit 60.

The fixing unit 60 heats and presses the continuous paper P on which the toner image has been formed with a fixing nip so that the toner image is fixed to the continuous paper P.

The fixing unit 60 includes a heating roller 61; a heat source 62 that heats the heating roller 61; the upper press roller 63; an endless fixing belt 61 that is stretched around the heating roller 61 and the upper press roller 63; and the lower press roller 65. The upper press roller 63 is driven to rotate by a not-illustrated motor. The heating roller 61 and the fixing belt 64 are rotated by the rotation of the upper press roller 63. The lower press roller 65 is driven to rotate by a motor 66 (shown in FIG. 3 and so forth).

The lower press roller 65 is movable. By being moved by the pressing-separating mechanism 67, the lower press roller 65 is pressed against the upper press roller 63 with the fixing belt 64 inbetween or is separated from the upper press roller 63, as shown in FIG. 8. The upper press roller 63 and the lower press roller 65 form the fixing nip by being pressed against each other with the fixing belt 64 inbetween. The continuous paper P is nipped and conveyed between the fixing nip. The continuous paper P is heated and pressed When passing through the fixing nip between the lower press roller 65 and the fixing, belt 64 that is heated by the heat source 62. Thus, the toner image is fixed to the continuous paper P. The upper press roller 63 and the lower press roller 65 constitute a pair of rotatable members of the present invention.

The communication unit 70 consists of a communication control card, such as a local area network (LAN) card. The communication unit 70 transmits and receives data to and from external devices (e.g. personal computer) connected to communication networks, such as a LAN or a wide area network (WAN), for example.

The paper winder 3 winds up the continuous paper P that has been conveyed from the main body 2. The paper winder 3 is driven by a not illustrated motor to wind up the continuous paper P that has been conveyed from the main body 2 around a support shaft Y. The winding operation of the paper winder 3 is controlled by a not-illustrated controller.

### Operation of Image Forming Apparatus 100

Next, operation of the image forming apparatus 100 is described.

The operation modes of the image forming apparatus 100 include an image forming mode and a paper conveying mode.

In the image forming mode, the image former 40 forms an image on the continuous paper P, and the fixing unit 60 nips and conveys the continuous paper P to fix the image to the continuous paper P. In the image forming mode, the upper press roller 63 and the lower press roller 65 of the fixing unit 60 are pressed against each other as shown in FIG. 3, and the fixing unit 60 and the paper conveyor 50 convey the continuous paper R

In the paper conveying mode, the image former 40 does not form an image on the continuous paper P, and at least the paper conveyor 50 conveys the continuous paper P. When the continuous paper P is replaced or when the continuous paper P in use is cut in order to replace parts of the image forming apparatus 100, the paper needs to be joined before image formation. In order to avoid forming images on the paper joint, the joint needs to be conveyed downstream from the image former 40 in the paper conveying direction. In such a case, the paper conveying mode is performed to convey the continuous paper P to the downstream from the image former 40 in the paper conveying direction. When the paper conveying key of the operation receiver 32 is pressed while the image formation is not performed, the controller 10 switches the operation mode to the paper conveying mode, and causes at least the paper conveyor 50 (in this embodiment, the conveying rollers 54 of the paper conveyor 50) to convey the continuous paper P at a predetermined speed. When the stop key of the operation receiver 32 is pressed, the controller 10 stops conveying the paper and ends the paper conveying mode. In the embodiments of the present invention, the paper conveying mode ends When the stop key of the operation receiver 32 is pressed. The present invention is not limited to this, though. The paper conveying mode may automatically end after the continuous paper P is conveyed by a predetermined distance, for example.

In the paper conveying mode, when the upper press roller 63 and the lower press roller 65 of the fixing unit 60 are pressed against each other to convey the continuous paper P, bumps at the paper joint or creases formed on the meandering continuous paper P may leave crease marks on the lower press roller 65. Such a lower press roller may fix images unevenly in the image forming mode and produce defective images. To deal with this, in the known art, when the lower press roller 65 does not have a heat source, the lower press roller 65 and the upper press roller 63 of the fixing unit 60 are separated in the paper conveying mode as shown in FIG. 4, and the conveying members on the paper conveying path 52 different from the fixing unit 60 (e.g., the conveying rollers 54) convey the paper.

However, in order to convey a bending-resistant paper (e.g., thick paper) as the continuous paper P, the conveying rollers 54 are required to have a strong paper conveying power to bend the continuous paper P at the winding roller part on the paper conveying path 52 (e.g., the part enclosed by the alternate-long-and-short dash line in FIG. 1). If the paper conveying power [N] of the conveying rollers 54 is weak, the conveying rollers 54 may not be able to convey the continuous paper Pat a predetermined speed. For example, in order to keep the tension between the fixing unit 60 and the downstream conveying rollers 54, the paper conveying speed of the conveying rollers 54 needs to be equal to or greater than the paper conveying speed of the fixing unit 60. Therefore, the paper conveying power of the conveying rollers 54 is set weaker than the, paper conveying power of the fixing unit 60. When the conveying rollers 54 convey the paper in the paper conveying mode while the fixing unit 60 is in the separated state, the conveying rollers 54 may not be able to convey the paper at a predetermined speed depending on the type or the basis weight of the continuous paper P.

To deal with the above issue, the controller 10 of the image forming apparatus 100 determines whether to set the upper press roller 63 and the lower press roller 65 of the fixing unit 60 to the pressed state or the separated state in the paper conveying mode as shown in FIG. 4, on the basis of a predetermined criterion. On the basis of the determination, the controller 10 conveys the continuous paper P while keeping the upper press roller 63 and the lower press roller 65 of fixing unit 60 in the pressed state or in the, separated state.

Specifically, in this embodiment, when the paper information of the continuous paper P is associated with “separating” in the pressing-separating determination table 21, namely when the continuous paper P can be conveyed by the conveying rollers 54 in the paper conveying mode, the controller 10 determines to separate the upper press roller 63 and the lower press roller 65 of the fixing unit 60 (separated state), and conveys the continuous paper P in the separated state. When the paper information of the continuous paper P is associated with “pressing” in the pressing-separating determination table 21, namely when the continuous paper P cannot be conveyed by the conveying rollers 54 in the paper conveying mode, the controller 10 determines to press the upper press roller 63 and the lower press roller 65 of the fixing unit 60 against each other (pressed state), and conveys the continuous paper P with the additional paper conveying power of the fixing unit 60.

FIG. 6 is a flowchart of a paper-conveying-mode process A to be performer by the controller 10. The paper-conveying-mode process A is performed by the CPU 10a of the controller 10 and the program stored in the ROM 10b when the paper conveying key of the operation receiver 32 is pressed and the paper conveying mode is instructed.

In the description below, pressing the lower pressing roller 65 against the upper press roller 63 may be ill referred to as pressing the fixing unit 60, and separating the lower press roller 65 from the upper press roller 63 may be referred to as separating the fixing unit 60. In the description below, the fixing unit 60 is originally separated in the paper conveying mode.

The controller 10 obtains paper information of the continuous paper P from the storage 20 (Step S1).

On the basis of the paper information of the continuous paper P, the controller 10 determines to set the fixing unit 60 to the pressed state or the separated state (Step S2).

Specifically, when the paper information of the continuous paper P is associated with “pressing” in the pressing-separating determination table 21, the controller 10 determines to set the fixing unit 60 to the pressed state. When the paper information of the continuous paper P is associated with “separating” in the pressing-separating determination table 21, the controller 10 determines to set the fixing unit 60 to the separated state.

When determining to set the fixing unit 60 to the pressed state (Step S3: YES), the controller 10 causes the pressing-separating mechanism 67 to press the fixing unit 60 (Step S4) and proceeds to Step S5. Herein, the controller 10 controls the pressing-separating mechanism 67 such that the pressing force between the upper press roller 63 and the lower press roller 65 in the paper conveying mode is weaker than the pressing force between the upper press roller 63 and the lower press roller 65 in the image forming mode. This is to reduce damage on the lower press roller 65 (e.g., to avoid generation of creases).

On the other hand, when determining to set the fixing unit 60 to the separated state (Step S3: NO), the controller 10 proceeds to Step S5.

In Step S5, the controller 10 controls the respective motors to convey the continuous paper P (Step S5).

When the fixing unit 60 is in the pressed state, the respective rollers of the conveying rollers 54 and the fixing unit 60 are rotated to convey the continuous paper P. When the fixing unit 60 is in the separated state, the conveying rollers 54 are rotated to convey the continuous paper P.

When the stop key of the operation receiver 32 is pressed to end the paper conveying mode (Step S6: YES), the controller 10 ends the paper-convoying-mode process A.

When the continuous paper P is thin paper that easily bears creases, the continuous paper P can be conveyed only by the conveying rollers 54 with a weak paper conveying power. Therefore, in the paper-conveying-mode process A, the thin continuous paper P is conveyed only by the conveying rollers 54 while the fixing unit 60 is in the separated state in order to prevent crease marks on the lower press roller 65. On the other hand, when the continuous paper P is thick paper, a large paper conveying power is required. Therefore, the thick continuous paper P is conveyed while the fixing unit 60 is in the pressed state. Since the thick paper is less likely to bear creases and the fixing unit 60 is only required to have a pressing force sufficient for conveying the paper, the lower press roller 65 is less likely to receive damage. Therefore, even if there is no heat source for the lower press roller 65, the lower press roller 65 is less likely to bear creases, and the image forming apparatus 100 can stably convey both thin paper and thick paper in the paper conveying mode.

### Second Embodiment

Next, a second embodiment of the present invention is described.

In the first embodiment, the controller 10 determines to set the fixing unit 60 to the pressed state or the separated state in the paper conveying mode on the basis of the paper information of the continuous paper P, as an example. In the second embodiment, the controller 10 obtains the drive torque (information on the drive torque) of the motor 55 that drives the conveying rollers 54 after starting the paper conveying mode and, on the basis of comparison between the obtained drive torque and a predetermined threshold, determines to set the fixing unit 60 to the pressed state or the separated state.

Since the configuration of the second embodiment is the same as that of the first embodiment, the description on the first embodiment is applied to the second embodiment. Hereinafter, the operation in the second embodiment is described.

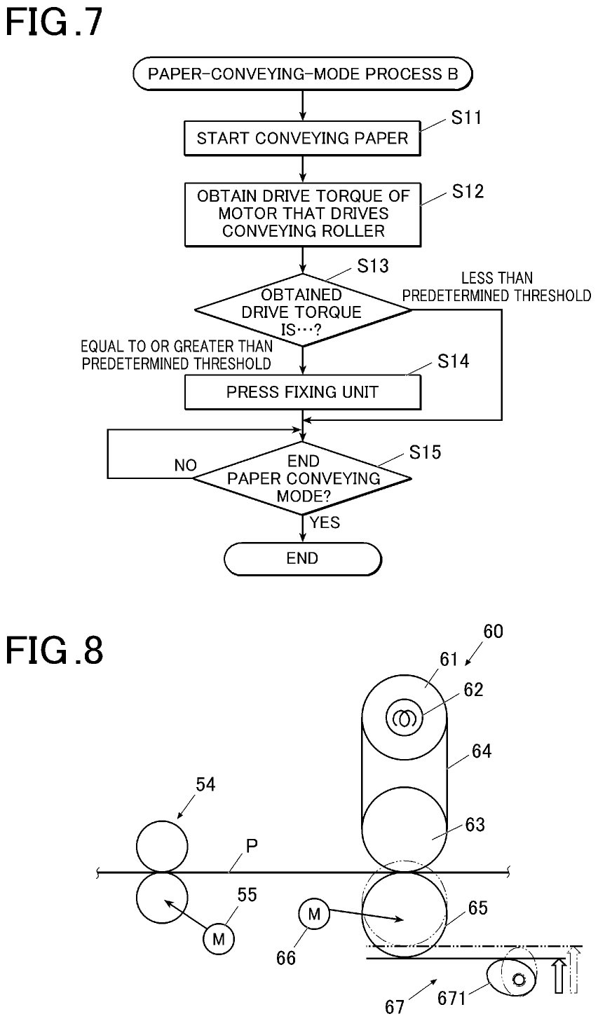

FIG. 7 is a flowchart of a paper-conveying-mode process B that is performed by the controller 10. The paper-conveying-mode process B is performed by the CPU 10a of the controller 10 and the program stored in the ROM 10b when the paper conveying key of the operation receiver 32 is pressed and the paper conveying mode is instructed.

The controller 10 causes the motor 55 to rotate the conveying rollers 54 and starts conveying the continuous paper P while keeping the fixing unit 60 in the separated state (Step S11).

The controller 10 obtains the drive torque of the motor 55 (information on the drive torque) (Step S12).

The controller 10 regulates the duty cycle or the current amount applied to the motor 55 in order to rotate the conveying rollers 54 at a predetermined speed. For example, for a thick continuous paper P, a greater force (drive torque) needs to be applied to the conveying rollers 54 than for a thin continuous paper P in order to rotate the conveying rollers 54 at a predetermined speed. Therefore, the controller 10 regulates the duty cycle or the current amount (current value) applied to the motor 55 such that the duty cycle or the current amount for thick continuous paper P is greater than that for thin continuous paper P. The duty cycle or the current amount applied to the motor 55 corresponds to the drive torque of the motor 55. The greater the duly cycle or the current amount is, the greater the drive torque of the motor 55 is. Therefore, in this embodiment, the controller 10 obtains information on the duty cycle or the current amount given to the motor 55 as the drive torque of the motor 55 (information on the drive torque). There may be provided a drive torque detector that detects the drive torque of the motor 55, and the controller 10 may obtain the drive torque of the motor 55 from the drive torque detector.

The controller 10 determines whether the obtained drive torque is equal to or greater than a predetermined threshold (Step S13).

For example, the predetermined threshold is a limit of the drive torque indicating that the drive torque should not be set equal to or greater than the limit because the motor 55 may be broken when the drive torque is equal to or greater than the limit. That is, when the obtained drive torque is equal to or greater than the predetermined threshold, it can be determined that the conveying rollers 54 alone cannot convey the continuous paper P at a predetermined speed (the continuous paper P cannot be conveyed when the fixing unit 60 is in the separated state). The predetermined threshold is obtained through experiments.

When determining that the obtained drive torque is equal to or greater than the predetermined threshold (Step S13: equal to or greater than the predetermined threshold), the controller 10 determines to set the fixing unit 60 to the pressed state, and on the basis of the determination, causes the pressing-separating mechanism 67 to press the fixing unit 60 and rotates the respective rollers of the fixing unit 60 (Step S14). The controller 10 then proceeds to Step S15. The controller 10 thus causes both the conveying rollers 54 and the fixing unit 60 to convey the continuous paper P. The rollers of the fixing unit 60 may be rotated beforehand. Herein, the controller 10 controls the pressing-separating mechanism 67 such that the pressing force between the upper press roller 63 and the lower press roller 65 in the paper conveying mode is weaker than the pressing force between the upper press roller 63 and the lower press roller 65 in the image forming mode. This is to reduce damage on the lower press roller 65 (e.g., to avoid generation of creases).

When determining that the obtained drive torque is less than the predetermined threshold (Step S13: less than predetermined threshold), the controller 10 proceeds to Step S15. That is, the controller 10 causes only the conveying rollers 54 to continue conveying the continuous paper P while keeping the fixing unit 60 in the separated state.

In Step S15, the controller 10 determines whether the stop key of the operation receiver 32 pressed and the instruction to end the paper conveying mode is received (Step S15).

When determining that the instruction to end the paper conveying mode is not received (Step S15: NO), the controller 10 continues to convey the continuous paper P until receiving the instruction to end the paper conveying mode.

When the instruction to end the paper conveying mode is received (Step S15: YES), the controller 10 ends the paper-conveying-mode process B.

In the paper-conveying mode process B, when the drive torque of the motor 55 for rotating the conveying rollers 54 is less than the predetermined threshold, the continuous paper P can be sufficiently conveyed by the conveying rollers 54 only. Therefore, the fixing unit 60 is kept in the separated state while the continuous paper P is conveyed. This can prevent crease marks on the lower press roller 65 in the paper conveying mode. When the drive torque of the motor 55 is equal to or greater than the predetermined threshold, the continuous paper P cannot be sufficiently conveyed by the conveying rollers 54 only. Therefore, the fixing unit 60 is set to the pressed state to convey the continuous paper P. Since the thick paper, which requires a large drive torque to convey, is less likely to bear creases and the fixing unit 60 is only required to have a pressing force sufficient for conveying the paper, the lower press roller 65 is less likely to receive damage. Therefore, even if there is no heat source for the lower press roller 65, the fixing unit 60 is less likely to bear creases, and the image forming apparatus 100 can stably convey both thin paper and thick paper in the paper conveying mode.

In the paper-conveying mode process B, when the fixing unit 60 is pressed, the pressing force of the fixing unit 60 may be adjusted according to the drive torque of the motor 55 obtained during the paper conveying mode.

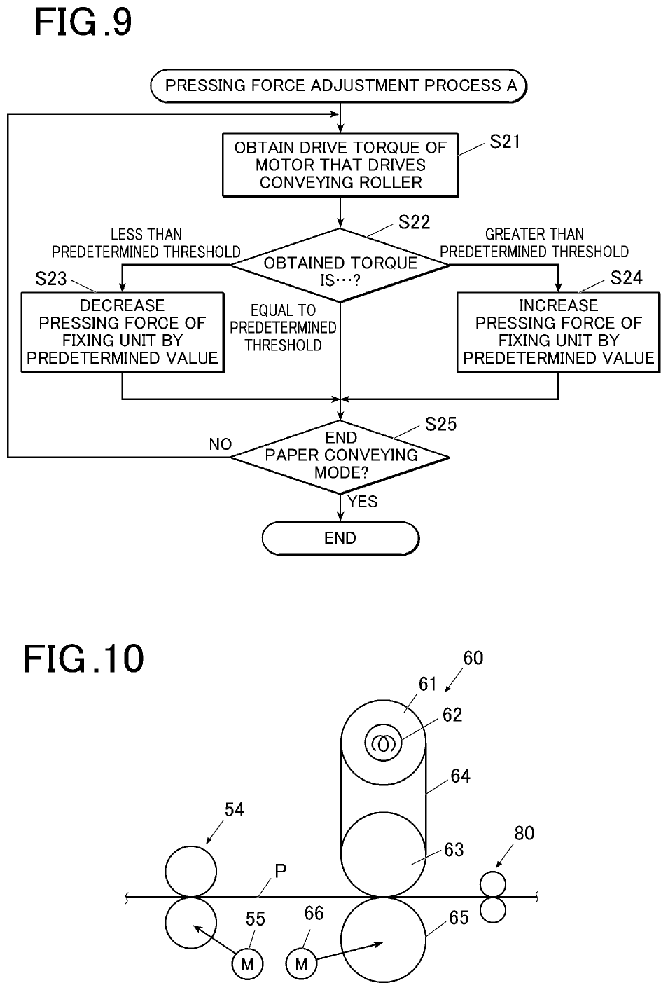

For example, as shown in FIG. 8, the pressing-separating mechanism 67 is not only configured to switch between pressing and separating by using an eccentric cam 671 but is also configured to serve as a pressing force adjuster that adjusts the pressing force of the fixing unit 60. When the fixing unit 60 is pressed in the paper-conveying mode process B, the controller 10 performs a pressing force adjustment process A in FIG. 9 to adjust the pressing force of the fixing unit 60 with the pressing-separating mechanism 67 according to the drive torque obtained during the paper conveying mode.

The pressing-separating mechanism 67 (pressing force adjuster) may be constituted of a solenoid.

Hereinafter, the pressing force adjustment process A is described with reference to FIG. 9.

In the pressing force adjustment process A, the controller 10 obtains the drive torque of the motor 55 for rotating the conveying rollers 54 (information on the drive torque) (Step S21). The controller 10 determines whether the obtained drive torque is less than the predetermined threshold, equal to the predetermined threshold, or greater than the predetermined threshold (Step S22).

The predetermined threshold used in Step S22 is the same as the threshold used for the determination in Step S13 in FIG. 7.

When determining that the obtained information on the drive torque is less than the predetermined threshold (Step S22: less than predetermined threshold), the controller 10 decreases the pressing force of the fixing unit 60 by a predetermined value by controlling the pressing-separating mechanism 67 (Step S23). The controller 10 then proceeds to Step S25.

When determining that the obtained drive torque is equal to the predetermined threshold (Step S22: equal to predetermined threshold), the controller 10 proceeds to Step S25.

When determining that the obtained information on the drive torque is greater than the predetermined threshold (Step S22: greater than predetermined threshold), the controller 10 increases the pressing force of the fixing unit 60 by a predetermined value by controlling the pressing-separating mechanism 67 (Step S23). The controller 10 then proceeds to Step S25.

In Step S25, the controller 10 determines whether the instruction to end the paper conveying mode is received (Step S25).

When the instruction to end the paper conveying mode is not received (Step S25: NO), the controller 10 returns to Step S21.

When the instruction to end the paper conveying mode is received (Step S25: YES), the controller 10 ends the pressing force adjustment process A.

Thus, the controller 10 obtains the drive torque of the motor 55 during the paper conveying mode and adjusts the pressing force of the fixing unit 60 according to the obtained drive torque. Therefore, the pressing force of the fixing unit 60 can be minimized, and creases on the lower press roller 65 of the fixing unit 60 can be prevented to the extent possible.

### Third Embodiment

Next, a third embodiment of the present invention is described.

In the third embodiment, the controller 10 obtains the paper speed of the continuous paper P after starting the paper conveying mode and, on the basis of comparison between the obtained paper speed (information on the paper speed) and a predetermined threshold, the controller 10 determines to set the fixing unit 60 to the pressed state. or the separated state in the paper conveying mode.

In the third embodiment, the image forming apparatus 100 includes a paper speed detector 80 that detects the speed of the continuous paper P on the paper conveying path 52, as shown in FIG. 10. The paper speed detector 80 is connected to the controller 10 and outputs the detected paper speed to the controller 10.

FIG. 10 shows the paper speed detector 80 that detects the speed of the continuous paper P by using a roller nip in contact with the continuous paper P. Instead, the paper speed detector 80 may detect the speed of the continuous paper P by using a laser Doppler, for example, without being in contact with the continuous paper P.

The other components of the third embodiment are the same as those of the first embodiment. Therefore, the description on the first embodiment is applied to the third embodiment. Hereinafter, the operation in the third embodiment is described.

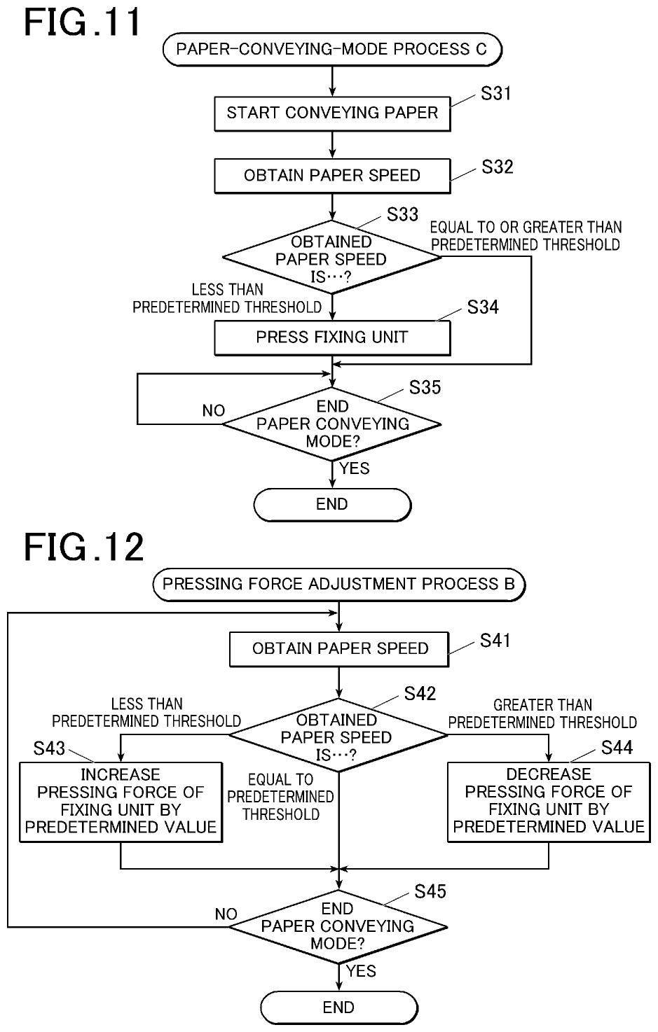

FIG. 11 is a flowchart of a paper-conveying-mode process C that is performed by the controller 10. The paper-conveying-mode process C is performed by the CPU 10a of the controller 10 and the program stored in the ROM 10b when the paper conveying button of the operation receiver 32 is pressed and the paper conveying mode is instructed.

The controller 10 causes the rooter 55 to rotate the conveying rollers 54 and starts conveying the continuous paper P while keeping the fixing unit 60 in the separated state (Step S31).

The controller 10 obtains the paper speed detected by the paper speed detector 80 (information on the paper speed) (Step S32).

The controller 10 determines whether the obtained paper speed is equal to or greater than a predetermined threshold (Step S33).

Herein, the predetermined threshold is a predetermined standard paper speed (target paper speed) in the paper conveying mode, for example. In the, paper conveying mode, the rotation of the conveying rollers 54 is regulated such that the continuous paper P is conveyed at the predetermined paper speed. When the obtained paper speed is less than the predetermined threshold, it can be determined that the conveying rollers 54 alone cannot convey the continuous paper P at a predetermined speed (the continuous paper P cannot be conveyed when the fixing unit 60 is in the separated state). The predetermined threshold is obtained through experiments.

When determining that the obtained paper speed is less than the predetermined threshold (Step S33: less than predetermined threshold), the controller 10 determines to set the fixing unit 60 to the pressed state, and on the basis of the determination, causes the pressing-separating mechanism 67 to press the fixing unit 60 and rotates the respective rollers of the fixing unit 60 (Step S34). The controller 10 then proceeds to Step S35. The controller 10 thus causes both the conveying rollers 54 and the fixing unit 60 to convey the continuous paper P. The rollers of the fixing unit 60 may be rotated beforehand. Herein, the controller 10 controls the pressing-separating mechanism 67 such that the pressing force between the upper press roller 63 and the lower press roller 65 in the paper conveying mode is weaker than the pressing force between the upper press roller 63 and the lower press roller 65 in the image forming mode. This is to reduce damage on the lower press roller 65 (e.g., to avoid generation of creases).

When determining that the obtained paper speed is greater than the predetermined threshold (Step S33: greater than predetermined threshold), the controller 10 proceeds to Step S35. That is, the controller 10 causes only the conveying rollers 54 to continue conveying the continuous paper P while keeping the fixing unit 60 in the separated state.

In Step S35, the controller 10 determines whether the stop button of the operation receiver 32 is pressed and the instruction to end conveying of the paper is received (Step S35).

When determining that the instruction to end conveying of the paper is not received (Step 535: NO), the controller 10 continues to convey the continuous paper P until conveying of the paper ends.

When the instruction to end conveying of the paper is received (Step S35: YES), the controller 10 ends the paper-conveying-mode process C.

In the paper-conveying-mode process C, when the paper speed of the continuous paper P detected by the paper speed detector 80 is equal to or greater than the predetermined threshold, the continuous paper P can be sufficiently conveyed only by the conveying rollers 54. Therefore, the fixing unit 60 is kept in the separated state while the continuous paper P is conveyed. This can prevent crease marks on the lower press roller 65. When the paper speed of the continuous paper P detected by the paper speed detector 80 is less than the predetermined threshold, the continuous paper P cannot be sufficiently conveyed by the conveying rollers 54 only. Therefore, the fixing unit 60 is set to the pressed state to convey the continuous paper P. Since the thick paper, which cannot be conveyed by the conveying rollers 54 only is less likely to bear creases and the fixing unit 60 is only required to have the pressing force sufficient for conveying the paper, the lower press roller 65 is less likely to receive damage. Therefore, even if there is no heat source for the lower press roller 65, the fixing unit 60 is less likely to bear creases, and the image forming apparatus 100 can stably convey both thin paper and thick paper in the paper conveying mode.

When the fixing unit 60 is pressed in the paper-conveying-mode process C, the pressing force of the fixing unit 60 may be adjusted according to the paper speed detected by the paper speed detector 80 during the paper conveying mode.

For example, as shown in FIG. 8, the pressing-separating, mechanism 67 is not only configured to switch between pressing and separating by using the eccentric earn 671 but is also configured to serve as a pressing force adjuster that adjusts the pressing force of the fixing unit 60. When the fixing unit 60 is pressed in the paper-conveying-mode process C, the controller 10 performs a pressing force adjustment process B shown in FIG. 12 to adjust the pressing force of the fixing unit 60 with the pressing-separating mechanism 67 according to the paper speed obtained during the paper conveying mode.

The pressing-separating mechanism 67 (pressing force adjuster) may be constituted of a solenoid.

Hereinafter, the pressing force adjustment process B is described with reference to FIG. 12.

In the pressing force adjustment process B, the controller 10 obtains the paper speed from the paper speed detector 80 (Step S41). The controller 10 determines whether the obtained paper speed (information on the paper speed) is less than a predetermined threshold, equal to the predetermined threshold, or greater than the predetermined threshold (Step S42).

The predetermined threshold used in Step S42 is the same as the threshold used for the determination in Step S33 in FIG. 11.

When determining that the obtained information on the paper speed is less than the predetermined threshold (Step S42: less than predetermined threshold), the controller 10 increases the pressing force of the fixing unit 60 by a predetermined value by controlling the pressing-separating mechanism 67 (Step S43). The controller 10 then proceeds to Step S45.

When determining that the obtained information on the paper speed is equal to the predetermined threshold (Step S42: equal to predetermined threshold), the controller 10 proceeds to Step S45.

When determining that the obtained information on the paper speed is greater than the predetermined threshold (Step S42: greater than predetermined threshold), the controller 10 decreases the pressing force of the fixing unit 60 by a predetermined value by controlling the pressing-separating mechanism 67 (Step S44). The controller 10 then proceeds to Step S45.

In Step S45, the controller 10 determines whether the instruction to end the paper conveying mode is received (Step S45).

When determining that the instruction to end the paper conveying mode is not received (Step S45: NO), the controller 10 returns to Step S41.

When determining that the instruction to end the paper conveying mode is received (Step S45: YES), the controller 10 ends the pressing force adjustment process C.

Thus, the controller 10 adjusts the pressing force of the fixing unit 60 according to the paper speed obtained during the paper conveying mode. Therefore, the pressing force of the fixing unit 60 can be minimized, and creases on the lower press roller 65 of the fixing unit 60 can be prevented to the extent possible.

As described above, in the paper conveying mode, the controller 10 of the image forming apparatus 100 determines to press or separate the fixing unit 60 on the basis of a predetermined criterion and conveys the continuous paper P while keeping the fixing unit 60 pressed or separated.

For example, the, controller 10 determines to press or separate the fixing unit 60 on the basis of whether the paper information of the continuous paper P is certain paper information that is associated with “pressing” in the pressing-separating determination table 21.

For another example, in the paper conveying mode, the controller 10 obtains the drive torque of the motor 55 while causing the conveying rollers 54 to convey the continuous paper P and keeping the fixing unit 60 separated, and on the basis of comparison between the obtained drive torque and a predetermined threshold, the controller 10 determines to press or separate the fixing unit 60.

For another example, in the paper conveying mode, the controller 10 obtains the paper speed of the continuous paper P from the paper speed detector 80 while causing the conveying rollers 54 to convey the continuous paper P and keeping the fixing unit 60 separated, and on the basis of comparison between the obtained paper speed and a predetermined threshold, the controller 10 determines to press or separate the fixing unit 60.

According to such a configuration, in the paper conveying mode, the Lower press roller 65 of the fixing unit 60 is less likely to bear creases, and the image forming apparatus 100 can stably convey both thick paper and thin paper.

Preferably, in the paper conveying mode, the controller 10 may cause the pressing-separating mechanism 67 (pressing force adjuster) to adjust the pressing force of the fixing unit 60 when conveying the continuous paper P with the fixing unit 60 pressed, on the basis of the drive torque of the motor 55 or the paper speed detected by the paper speed detector 80, for example.

According to such a configuration, the pressing force of the fixing unit 60 can be adjusted according to the operation state in the paper conveying mode. Therefore, when the fixing unit 60 is pressed, the pressing force is adjusted to the minimum necessary force, and occurrence of creases on the lower press roller 65 is restrained.

Preferably, the controller 10 may perform control such that the pressing force of the fixing unit 60 in the paper conveying mode is weaker than the pressing force of the fixing unit 60 in the image forming mode. According to such a configuration, the pressing force is adjusted to the minimum necessary force, and occurrence of creases on the lower press roller 65 is restrained.

Preferably, in the image forming apparatus 100, the conveying rollers 54 used in the paper conveying mode may be provided downstream from the fixing unit 60 in the paper conveying direction. The paper conveying power of the conveying rollers 54 is weaker than the paper conveying power of the fixing unit 60. According to such a configuration, the lower press roller 65 is less likely to bear creases, and the image forming apparatus 100 can stably convey both thick paper and thin paper.

Preferably the fixing unit 60 may include a heat source that is provided outside the tower press roller 65. Specifically, the fixing unit 60 may include the fixing belt 64 that is stretched around the upper press roller 63; and the heating roller 61 that is disposed at a position different from the position of the upper press roller 63 and that abuts the inside of the fixing belt 64, and the heat source 62 may be provided to the heating roller 61. According to such a configuration, the lower press roller 65 is less likely to bear creases, and the image forming apparatus 100 can stably convey both thick paper and thin paper.

The above-described embodiments are examples of the present invention and do not limit the present invention.

For example, in the second embodiment, the controller 10 obtains the drive torque of the motor 55 at the beginning of the paper conveying mode, and the controller 10 then determines to press or separate the fixing unit 60 on the basis of whether the obtained drive torque is equal to or greater than a predetermined threshold. Instead, the controller 10 may keep the fixing unit 60 in the separated state until the drive torque is equal to or greater than a predetermined threshold during the paper conveying mode; repeat obtaining the drive torque and comparing the obtained drive torque with the predetermined threshold without pressing the fixing unit 60 to convey the paper; and determine to press the fixing unit 60 when the drive torque is equal to or greater than the predetermined threshold. The controller 10 may thus press the fixing unit 60.

Similarly, in the third embodiment, the controller 10 obtains the paper speed of the continuous paper P from the paper speed detector 80 at the beginning of the paper conveying mode, and the controller 10 determines to press or separate the fixing unit 60 on the basis of whether the obtained paper speed is less than a predetermined threshold. Instead, the controller 10 may keep the fixing unit 60 in the separated state until the paper speed drops below the predetermined threshold during the paper conveying mode; repeat obtaining the paper speed and comparing the obtained paper speed with the predetermined threshold without pressing the fixing unit 60 to convey the paper; and determine to press the fixing unit 60 when the paper speed is less than the predetermined threshold. The controller 10 may thus press the fixing unit 60.

Further, when determining to press the fixing unit 60 in the paper-conveying-made process A in the first embodiment, the controller 10 may perform either the pressing three adjustment process A in FIG. 9 or the pressing three adjustment process B in FIG. 12 to adjust the pressing force.

In the above embodiment, the conveying rollers 54 are used in the paper conveying mode as conveying rollers different from the fixing unit 60. Herein, the conveying rollers 53 may be used, or both the conveying rollers 54 and the conveying rollers 53 may be used.

The detailed configuration and the detailed operation of the image forming apparatus can be suitably modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a continuous paper;
a fixing unit that includes a pair of rotatable members configured to be pressed against each other or be separated from each other and that nips the continuous paper between the rotatable members to convey the continuous paper and fix the image formed on the continuous paper by the image limner;
a conveying member different from the rotatable members; and
a hardware processor, wherein
an operation mode of the image forming apparatus includes a paper conveying mode in which the image former does not form an image and at least the conveying member conveys the continuous paper, and
in the paper conveying mode, the hardware processor determines to press the rotatable members of the fixing unit against each other or to separate the rotatable members from each other according to a predetermined criterion and, based on the determination, conveys the continuous paper while keeping the rotatable members pressed against each other or separated from each other.

2. The image forming apparatus according to claim 1, wherein
the hardware processor determines to press the rotatable members of the fixing unit against each other or to separate the rotatable members from each other, based on whether paper information regarding the continuous paper is predetermined paper information.

3. The image forming apparatus according to claim 1, wherein in the paper conveying mode,
the hardware processor obtains a drive torque of a drive unit that drives the conveying member, while causing the conveying member to convey the continuous paper and keeping the rotatable members separated from each other, and
based on comparison between the obtained drive torque and a predetermined threshold, the hardware processor determines to press the rotatable members of the fixing unit against each other or to separate the rotatable members from each other.

4. The image forming apparatus according to claim 1, further comprising a detector that detects a paper speed of the continuous paper, wherein in the paper conveying mode,
the hardware processor obtains the paper speed of the continuous paper from the detector while causing the conveying member to convey the continuous paper and keeping the rotatable members separated from each other, and
based on comparison between the obtained paper speed and a predetermined threshold, the hardware processor determines to press the rotatable members of the fixing unit against each other or to separate the rotatable members from each other.

5. The image forming, apparatus according to claim 1, further comprising a pressing force adjuster that adjusts a pressing force between the rotatable members of the fixing unit, wherein
when conveying the continuous paper while keeping the rotatable members pressed against each other in the paper conveying mode, the hardware processor causes the pressing force adjuster to adjust the pressing force between the rotatable members.

6. The image forming apparatus according to claim 1, wherein
the conveying member is provided downstream from the fixing unit in a paper conveying direction.

7. The image forming apparatus according to claim 1, wherein
a paper conveying power of the conveying member is weaker than a paper conveying power of the fixing unit.

8. The image forming apparatus according to claim 1, wherein
the operation mode of the image forming apparatus includes an image forming mode in which the image former forms an image on the continuous paper and the rotatable members nip the continuous paper between the rotatable members to convey the continuous paper and fix the image formed on the continuous paper to the continuous paper, and
the hardware processor performs control such that a pressing force between the rotatable members in the paper conveying mode is weaker than a pressing force between the rotatable members in the image forming mode.

9. The image forming apparatus according to claim 1, wherein
the fixing unit includes a heat source that is provided outside the rotatable members.

10. The image forming apparatus according to claim 9, wherein
the fixing unit includes:
a belt that is stretched around one of the rotatable members; and
a heating roller that is disposed at a position different from a position of the one of the rotatable members and that abuts an inside of the belt, and
the heat source is provided to the heating roller.
